(19) United States
(12) Patent Application Publication
(10) Pub. No.: US 2002/0114615 A1
(43) Pub. Date: Aug. 22, 2002

(54) Image processing apparatus and method for moving picture data playback, and computer-readable storage medium that stores program codes for image processing

(75) Inventors: Hiroshi Tojo, Tokyo (JP); Kazuyo Ikeda, Tokyo (JP)

Correspondence Address: HOGAN & HARTSON L.L.P., 500 S. GRAND AVENUE, SUITE 1900, LOS ANGELES, CA, 90071-2611, US

(73) Assignee: CANON KABUSHIKI KAISHA

(21) Appl. No.: 10/033,827

(22) Filed: Dec. 19, 2001

(30) Foreign Application Priority Data
Dec. 27, 2000 (JP) 399040/2000

(51) Int. Cl. H04N 5/91

(52) U.S. Cl. 386/68

(57) ABSTRACT

An image processing method for playing back a moving picture includes storing scene information associated with the moving picture including, at least, data for representative frames of scenes, data for intervals of the scenes, and data for hierarchical levels of the scenes; a display step for chronologically displaying images of the representative frames of the scenes stored in the storing step on a display device based on the external designation of the hierarchical level; and a playback step to play back one of the scenes corresponding to the representative frame displayed by the display device based on an external playback instruction.

### BACKGROUND OF THE INVENTION

1. Field of the Invention

The present invention relates to an image processing apparatus, an image processing method and a storage medium in which image processing steps are stored in a computer-readable manner, which are used in, for example, apparatuses or systems for moving picture playback.

2. Description of Related Art

Conventionally, if the user wants to see only scenes that he or she is interested in on an image processing apparatus that plays back video pictures (moving pictures) recorded on a tape recording medium such as a videotape, for example, the user instructs the image processing apparatus to play back the moving pictures of those scenes by operating the fast forward button or the rewind button provided on the operation section of the image processing apparatus. The user also instructs the image processing apparatus to perform a double-speed playback by operating various buttons on the operation section of the image processing apparatus, determines if the scenes are indeed scenes that he or she is really interested in based on the moving pictures thus played back, and if so, the user instructs the image processing apparatus to rewind once again and then instructs a normal playback.

However, in the conventional image processing apparatus described above, when the user instructs a fast forward or rewind operation of moving picture playback by operating various buttons on the operation section in order to view the desired scenes, a problem of fast forwarding too much or rewinding too much may occur. Consequently, the user is forced to repeat a similar operation many times in order to view the desired scenes. Furthermore, repeating the operation (e.g., a rewind or fast forward operation) many times results in interrupting the playback of moving pictures many times, which leads to a difficulty for the user to ascertain the order of scenes. In addition, when the playback is done on a double-speed playback, the longer the scene, the longer it takes to determine the content of the scene.

### SUMMARY OF THE INVENTION

In view of the problems described above, it is a feature of the present invention to provide an image processing apparatus, a method for processing images, and a computer-readable storage medium in which program codes for the image processing are stored, which would make efficient viewing possible through a structure that allows a quick determination of the details of the content (scene) without interrupting the playback of moving pictures.

An image processing apparatus in accordance with a preferred embodiment of the present invention includes: a storage device that stores scene information including, at least, data for a representative frame of a scene, data for an interval of the scene and data for a hierarchical level of the scene of each of a plurality of scenes included in a moving picture that is subject to a playback; a display device that reads images of the representative frames of the plurality of scenes from the storage device and chronologically displays the images based on an external designation of a hierarchical level,; and a playback device that plays back, based on an external playback instruction, at least one of the plurality of scenes corresponding to the images of the representative frames displayed through the display device.

An image processing apparatus in accordance with another preferred embodiment of the present invention relates to an image processing apparatus for playing back moving pictures, the image processing apparatus includes a storage device that stores scene information including, at least, data for a representative frame of a scene and data for a hierarchical level of the scene of each of a plurality of scenes included in a moving picture that is subject to a playback; and a display device that chronologically displays images of the representative frames of the plurality of scenes based on an external designation of a hierarchical level.

An image processing method in accordance with one embodiment of the present invention relates to an image processing method for playing back a moving picture, the image processing method including: a storing step for storing scene information associated with the moving picture including, at least, data for representative frames of scenes, data for intervals of the scenes and data for hierarchical levels of the scenes; a hierarchical level designation step for designating a hierarchical level; a display step for chronologically displaying images of the representative frames of the scenes stored in the storing step on a display device based on the hierarchical level designated in the hierarchical level designation step; a representative frame designation step for designating one of the representative frames displayed by the display device; and a playback step for playing back one of the scenes corresponding to the representative frame designated in the representative frame designation step.

An image processing method in accordance with another preferred embodiment of the present invention relates to an image processing method for playing back a moving picture, the image processing method including: a storage step for storing scene information including, at least, data for a representative frame of a scene and data for a hierarchical level of the scene of each of a plurality of scenes included in a moving picture that is subject to a playback; and a display step for chronologically displaying images of the representative frames of the plurality of scenes based on an external designation of the hierarchical level.

A computer-readable storage medium in accordance with a preferred embodiment of the present invention relates to a computer-readable storage medium that stores image processing program codes to play back a moving picture, the computer-readable storage medium storing: a code for a storing step for storing scene information associated with the moving picture including, at least, data for representative frames of scenes, data for intervals of the scenes, and data for hierarchical levels of the scenes; a code for a hierarchical level designation step for designating a hierarchical level; a code for a display step for chronologically displaying images of the representative frames of the scenes stored in the storing step on a display device based on the hierarchical level designated in the hierarchical level designation step; a code for a representative frame designation step for designating one of the representative frames displayed by the display device; and a code for a playback step for playing back one of the scenes corresponding to the representative frame designated in the representative frame designation step.

A computer-readable storage medium in accordance with another preferred embodiment of the present invention relates to a computer-readable storage medium that stores image processing program codes for playing back a moving picture, the computer-readable storage medium storing: a code for a storage step for storing scene information including, at least, data for a representative frame of a scene and data for a hierarchical level of the scene of each of a plurality of scenes included in a moving picture that is subject to a playback; and a code for a display step for chronologically displaying images of the representative frames of the plurality of scenes based on an external designation of the hierarchical level.

Other features and advantages of the invention will become apparent from the following detailed description taken in conjunction with the accompanying drawings.

### BRIEF DESCRIPTION OF THE DRAWINGS

FIG. 1 is a block diagram showing a structure of an image processing apparatus to which the present invention is applied.

FIG. 2 is a block diagram showing a functional structure of the image processing apparatus.

FIG. 3 describes an example of scene information used in the image processing apparatus.

FIG. 4 is an illustration to describe an example of a block division of a frame when creating the scene information.

FIG. 5 is an illustration to describe an example of a user interface of the image processing apparatus.

FIG. 6 is a flow chart of an overall operation of the image processing apparatus.

FIG. 7 is a flow chart of an operation that takes place when the significance level 1 button is operated within the overall operation of the image processing apparatus.

FIG. 8 is a flow chart of an operation that takes place when the slide bar is operated within the overall operation of the image processing apparatus.

FIG. 9 is an illustration to describe the scene buttons in the user interface.

### DETAILED DESCRIPTION OF THE PREFERRED EMBODIMENT

Embodiments of the present invention are described below with reference to the accompanying drawings.

The present invention can be implemented in an image processing apparatus 100 shown in FIG. 1, for example.

The image processing apparatus 100 in accordance with the present embodiment has a scene extraction function structured to quickly determine the details of the content (scene) without interrupting the moving picture playback and has a structure in which a central processing unit (CPU) 101, a read-only memory (ROM) 102, a random access memory (RAM) 103, a keyboard 104, a mouse 105, an external storage device 106, a display unit 107 and a network interface card (NIC) 108 are connected in a manner that allows them to communicate with one another via a system bus 111.

The CPU 101 governs an overall operation control of the image processing apparatus 100 by executing predetermined processing programs. The ROM 102 stores processing programs to carry out operation controls in the CPU 101 (e.g., a boot program executed when the image processing apparatus 100 starts up) and various data. The RAM 103 functions as a memory in which processing programs are loaded from the ROM 102 by the CPU 101. Also, the RAM 103 is used as a working memory when the CPU 101 executes various operation controls.

The keyboard 104 and the mouse 105 provide an environment for various operation instructions (e.g., an environment for various input operations) by the user to the image processing apparatus 100. The external storage device 106 is formed from a hard disk, a floppy disk, a compact disc read-only memory (CD-ROM) or the like. The display unit 107 comprises a cathode ray tube (CRT) display and displays processing results to the user. The NIC 108 is a network interface that enables communication with various equipment and/or system on the network.

In the structure shown in FIG. 1, the external storage device 106 can be placed on a network that may be connected through the NIC 108.

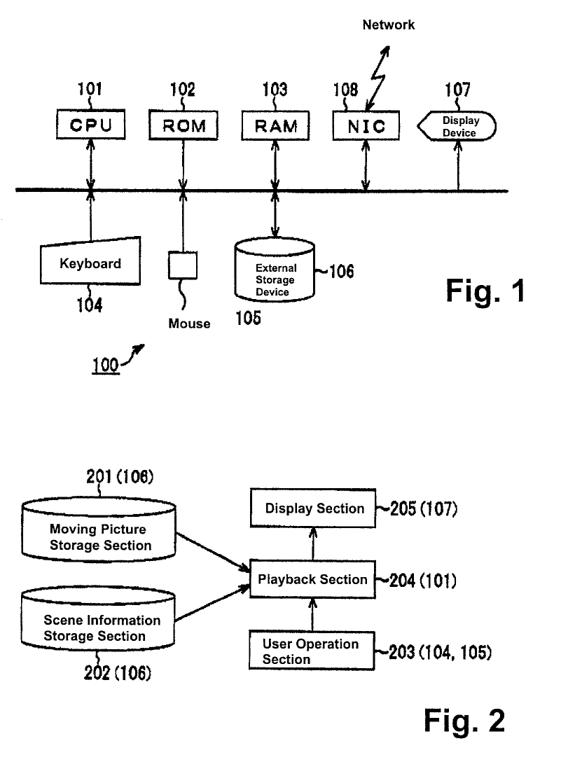

FIG. 2 schematically shows a functional diagram of the image processing apparatus 100 in FIG. 1.

The image processing apparatus 100, as shown in FIG. 2, is equipped with a moving picture storage section 201 and a scene information storage section 202, both executed by the external storage device 106; a display section 205 executed by the display unit 107; a playback section 204 executed by the CPU 101; and a user operation section 203 executed by the keyboard 104 and the mouse 105.

The moving picture storage section 201 stores groups of frames of a moving picture. It is noted that a moving picture may be comprised of a plurality of scenes, and each of the scenes may be comprised of a plurality of frames. The scene information storage section 202 (to be described in greater detail below) stores data for scenes including, at least, the length (scene interval) and the significance level (hierarchical level) of each scene in a moving picture. The user operation section 203 allows the user to give a moving picture playback instruction, a scene designation, and the like to the image processing apparatus 100. The instruction and designation are given through various operation sections such as buttons on the display screen of the display unit 107 (the display section 205), to be described in greater detail below.

The playback section 204 sequentially extracts, from the moving picture storage section 201, frames of the scenes designated by the user through the user operation section 203, and plays back the scenes as a moving picture while checking the information in the scene information storage section 202. The display section 205 displays and outputs to the user the moving picture played back by the playback section 204.

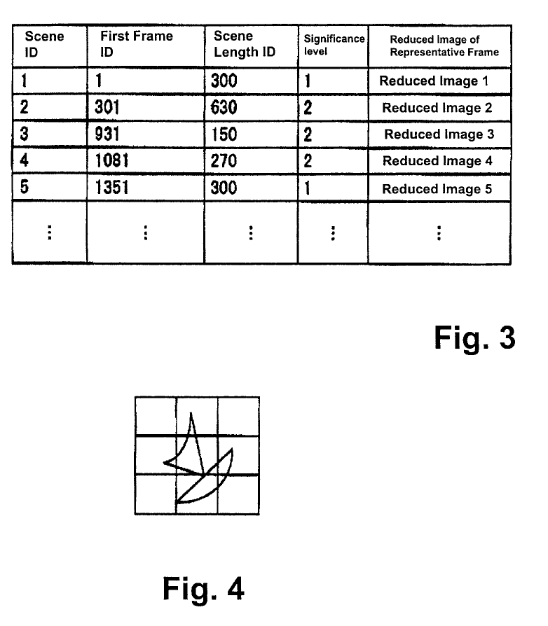

FIG. 3 shows a data structure of scene information stored in the scene information storage section 202.

In one embodiment, information for every scene (scene information) concerning the moving picture stored in the moving picture storage section 201 is stored in the scene information storage section 202 in accordance with the data structure shown in FIG. 3.

In FIG. 3, “Scene ID” is an identification (ID) to identify each scene. For each of the scenes designated with a scene ID, information such as the “First Frame ID,” “Scene Length” (Scene Interval), “Significance Level” (Hierarchical Level), and “Reduced Image of the Representative Frame” is added.

The “First Frame ID” is the ID of the frame at the beginning of the scene in question. The “Scene Length” expresses in number of frames the length of the scene in question.

The “Significance Level” refers to the level of significance of the scene in question. In the embodiments, “1” is the most significant and the level of significance diminishes in the order of “2,” “3,” “4,” etc. In the present embodiment, the lowest significance level is “2” to simplify the description, but there can certainly be significance levels of “3” and higher.

The “Reduced Image of the Representative Frame” refers to an image of a frame representative of the scene in question whose size is reduced.

The frame representing the scene in question may be the frame at the beginning of the scene, the frame at the end of the scene, or an arbitrary frame in the scene.

Some examples of methods for creating scene information as described above are the following methods (1) and (2):

(1) To manually check and separate a moving picture into individual scenes, and to assign a significance level to each scene.

(2) To automatically separate a moving picture into individual scenes by a specified process and to assign a significance level to each scene.

A more specific example for the method (2) is described below.

First, in a moving picture, the current frame and the preceding frame are respectively divided into blocks as shown in FIG. 4.

Next, an average value of each R, G and B channel is calculated for each of the blocks after the block division is performed. Differences between the average RGB values of the corresponding blocks of the current frame and the preceding frame are respectively squared and their sums are obtained. The result is considered a similarity distance between frames, which indicates the degree of severity of the scene change.

Consequently, the smaller the similarity distance between frames, the more similar the frames are to each other, and the larger the similarity distance between frames, the less similar the frames are to each other. In other words, the larger the similarity distance between frames, the greater the possibility that the present frame is in a different scene changed from the preceding frame.

By determining such scene changes, the frame in which a scene change takes place is used as the representative frame.

The above process is expressed by the formula (1) as follows:

$${\sum }_{i = 1}^{K} \{ {( {P1}_{i R} - {P2}_{i R} )}^{2} + {( {P1}_{i G} - {P2}_{i G} )}^{2} + {( {P1}_{i B} - {P2}_{i B} )}^{2} \} \qquad ( 1 )$$

where:

i is the block being processed;

K is the number of divided blocks;

P1_{iR} is the average value of R channel of the i-th block of the preceding frame;

P1_{iG} is the average value of G channel of the i-th block of the preceding frame;

P1_{iB} is the average value of B channel of the i-th block of the preceding frame;

P2_{iR} is the average value of R channel of the i-th block of the current frame;

P2_{iG} is the average value of G channel of the i-th block of the current frame; and

P2_{iB} is the average value of B channel of the i-th block of the current frame.

It may be difficult to automate the determination of the significance level of each scene. However, for example, such determination may be made by assuming that a scene that occurs repeatedly is an important scene. When the similarity between frames representing scenes is high, the scenes can be considered to be the same scene. In other words, the same scene occurs repeatedly, and such scenes can be considered to be important.

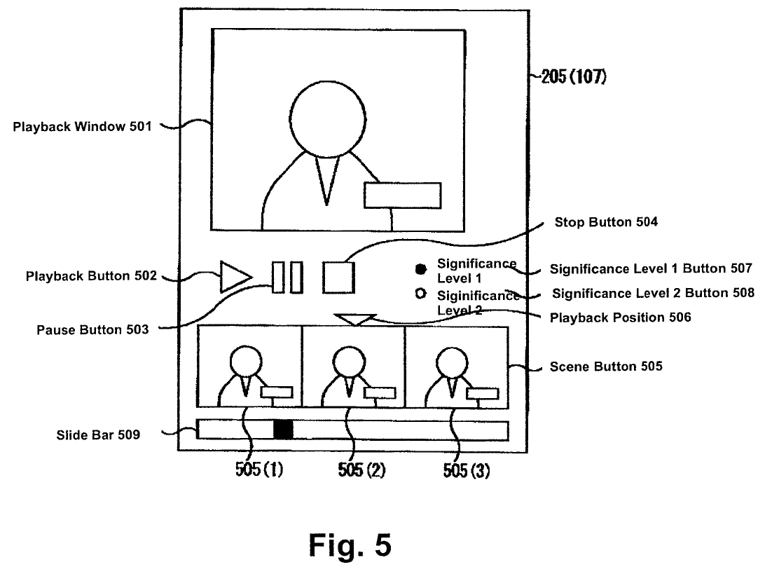

FIG. 5 shows an example of a display screen of the display section 205 (107) to which instructions can be given through the user operation section 203.

In FIG. 5, reference number 501 denotes a playback window to display a moving picture being played back. Reference number 502 denotes a playback button to instruct to begin the playback of the moving picture. Reference number 503 denotes a pause button to instruct to pause the playback of the moving picture. Reference number 504 denotes a stop button to instruct to stop the playback of the moving picture.

Reference number 505 denotes a scene button section that corresponds to the scene in the moving picture currently being played back and also displays a reduced image of the frame that represents that scene (the representative frame). The scene button section 505 consists of scene buttons 505 (1), 505 (2). . . 505 (n) for displayable scenes in chronological order from left to right. The scene buttons 505 (1), 505 (2). . . 505 (n) are synchronous with the moving picture displayed on the playback window 501, so that as the display of one scene ends, the left most (the chronologically oldest) scene button 505 (1) disappears, the other scene buttons 505 (2). . . 505 (n) shifts to the left, and the chronologically newest scene button 505 (n +1) appears in the right most space.

Reference number 506 denotes a playback position that indicates which scene button among the scene buttons 505 (1), 505 (2). . . 505 (n) corresponds to the scene being displayed (being played back) currently on the playback window 501.

Reference number 507 and reference number 508 denote a significance level 1 button and a significance level 2 button, respectively, and the significance level 1 button 507 and the significance level 2 button 508 can be switched from one to the other according to the significance level.

In one embodiment, for example, the significance level 1 button 507 and the significance level 2 button 508 may be formed from a radio button such that only one of the significance level 1 button 507 and the significance level 2 button 508 can be selected.

Reference number 509 denotes a slide bar for sliding scenes in the scene button section 505 to thereby display scene buttons 505 (x) corresponding to scenes that are not currently displayed in the scene buttons 505(1), 505(2) and 505(3) on the screen.

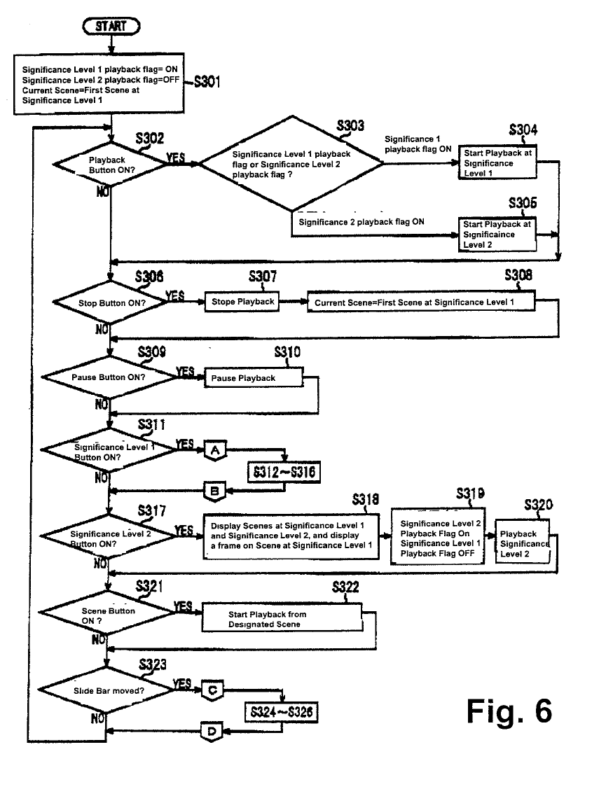

FIGS. 6 through 8 show operations of the image processing apparatus 100.

For example, when the CPU 101 reads and executes a processing program that is according to the flow charts indicated in FIGS. 6 through 8 and is stored in advance in the ROM 102, the image processing apparatus 100 operates as follows:

Step S301:

The playback section 204 sets the initial values when the image processing apparatus 100 starts. More specifically, the playback section 204, for example, sets a significance level 1 playback flag at “ON,” sets a significance level 2 playback flag at “OFF,” and designates the first scene (the scene at the beginning) at the significance level 1 as the current scene indicating the playback position.

Step S302, Step S306, Step S309, Step S311, Step S317, Step S321, Step S323:

The playback section 204 discriminates the user's operation (instruction) on the user operation section 203 (the display screen of the display section 205 in FIG. 5).

As a result, while the user does not instruct anything, the discriminating process beginning with step S302 is executed repeatedly. On the other hand, when the user carries out an operation on the display screen of the display section 205 in FIG. 5, one of the following processes that corresponds to the operation is executed:

Step S303 through Step S305:

When the playback button 502 is pressed (step S302), the playback section 204 checks which of the significance level 1 playback flag and the significance level 2 playback flag is “ON” (step S303); if the significance level 1 flag is “ON” the playback section 204 executes the playback processing of scenes at the significance level 1 (step S304), and if the significance level 2 flag is “ON”, the playback section 204 executes the playback processing of the scenes at the significance level 2 (step S305). The playback processing of the scenes at the significance level 1 refers to a processing to play back only those scenes whose significance levels are designated at “1” in the scene information (see FIG. 3) stored in the scene information storage section 202, and the playback processing of the scenes at the significance level 2 refers to a processing to play back only those scenes whose significance levels are designated at “2” or higher, in other words, the scenes whose significance levels are at “1” or at “2,” in the scene information stored in the scene storage section 202. After the process in step S304 or S305, the playback section 204 goes back to a standby mode to wait for an instruction from the user.

Step S307 and Step S308:

When the stop button 504 is pressed (step S306), the playback section 204 stops the playback operation of the moving picture (step S307) and once again resets the current scene indicating the playback position to the first scene (the scene at the beginning) that is at the significance level 1 (step S308). After the process in step S308, the playback section 204 goes back to a standby mode to wait for an instruction from the user.

Step S310:

When the pause button 503 is pressed (step S309), the playback section 204 pauses the playback operation of the moving picture (step S310). After the process in step S310, the playback section 204 goes back to a standby mode to wait for an instruction from the user. In this case, the pause state continues until the playback button 502 or the scene button 505 is pressed again.

Step S312 through Step S316:

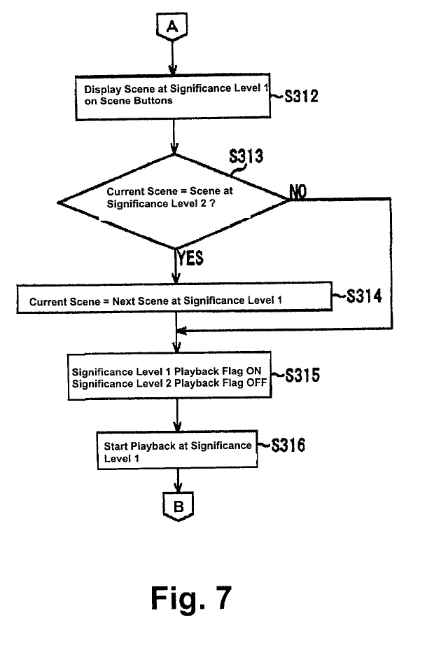

Referring to FIG. 7, when the significance level 1 button 507 is pressed (step S311), the playback section 204 executes the processes in step S312 through step S316 indicated in FIG. 7.

In other words, first, the playback section 204 reads, from the scene information (see FIG. 3) in the scene information storage section 202, reduced images of the representative frames of the scenes being designated at the significance level 1 and displays the reduced images on the scene buttons 505 (X) (step S312).

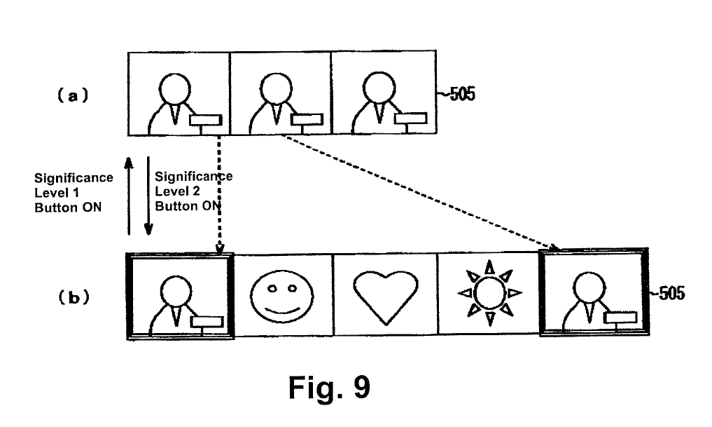

For example, when a moving picture that is the subject of a playback is a video of a news program, scenes in which a news anchor relates a summary of each news item can be deemed to have a high significance level since the content can be ascertained by these scenes alone, while scenes of reporting from locations can be deemed to have a low significance level. Consequently, assuming that the scenes in which the news anchor relates the summary of each news item are designated the significance level of “1” and that the scenes of reporting from locations are designated the significance level of “2,” reduced images of representative frames of the scenes in which the news anchor relates the summary of each news item and that are designated the significance level of “1” would occupy the scene button section 505, for example, as shown in FIG. 9 (a). In one embodiment, frames with captions for each news item may be used as the representative frames, for example. As a result, the user can more easily ascertain the news items.

Next, the playback section 204 discriminates whether or not a scene at the significance level 2 is set for the current scene (step S313).

As a result of this discrimination, when a state in which “the current scene is a scene at the significance level 2” is not found, in other words, when a scene at the significance level 1 is set for the current scene, the playback section 204 proceeds to step S315 (to be described below), instead of executing the process in the next step S314.

On the other hand, as a result of the discrimination in step S313, if the state in which “the current scene is a scene at the significance level 2 scene” is found, the playback section 204 sets the next scene at the significance level 1 for the current scene (step S314) and proceeds to the next step S315.

For example, a state in which “the current scene is a scene at the significance level 2” can be a state in which a process for playing back a scene at the significance level 2 can be executed. In such a state, the next scene at the significance level 1 closest to the current scene is set for the current scene. As a result, scenes being currently played back are prevented from disappearing from the scene button section 505. To this end, it is also acceptable to set the previous scene at the significance level 1 closest to the current scene as the current scene.

In step S315, the playback section 204 sets the significance level 1 playback flag “ON” and the significance level 2 playback flag “OFF.”

The playback section 204 then begins to execute the significance level 1 playback process (step S316).

After executing the processes described for steps S312 through S316, the playback section 204 goes back to a standby mode to wait for an instruction from the user.

Step S318 through Step S320:

Referring back to FIG. 6, when the significance level 2 button 508 is pressed (step S317), the playback section 204 reads reduced images of the representative frames of the scenes having the significance level 1 and the significance level 2 from the scene information (see FIG. 3) in the scene information storage section 202 and displays the reduced images on the scene buttons 505 (X) (step S318).

For instance, if the current scene button section 505 is in a state that displays the reduced images of the representative frames of the scenes at the significance level 1 as shown in FIG. 9 (a) (the reduced images of the representative frames from the scenes in which the news anchor relates the summary), the playback section 204 additionally displays the reduced images of the representative frames of the scenes at the significance level 2 (the reduced images of the representative frames from the on-location scenes) in the scene buttons 505 (X). Consequently, as shown in FIG. 9 (b), their display condition is changed. More specifically, as shown in FIG. 9 (b), the reduced images of the representative frames of the scenes in which the news anchor is relating the summary and the reduced images of representative frames of the on-location scenes appear in succession. At this time, an emphasized “frame” is displayed on scene buttons 505 (X) for each of the reduced images of the representative frames of the scenes at the significance level 1 in order to distinguish them from those of the scenes at the significance level 2 (see FIG. 9 (b)).

Next, the playback section 204 sets the significance level 2 playback flag “ON” and the significance level 1 playback flag “OFF” (step S319). The playback section 204 then begins to execute the significance level 2 playback process (step S320). The process subsequently goes back to a standby mode to wait for an instruction from the user.

Step S322:

When a desired scene button 505 (X) in the scene button section 505 is pressed (step S321), the playback section 204 begins the playback process from the beginning of the scene indicated by the scene button 505 (X). The playback section 204 subsequently goes back to a standby mode to wait for an instruction from the user.

Step S324 through Step S326:

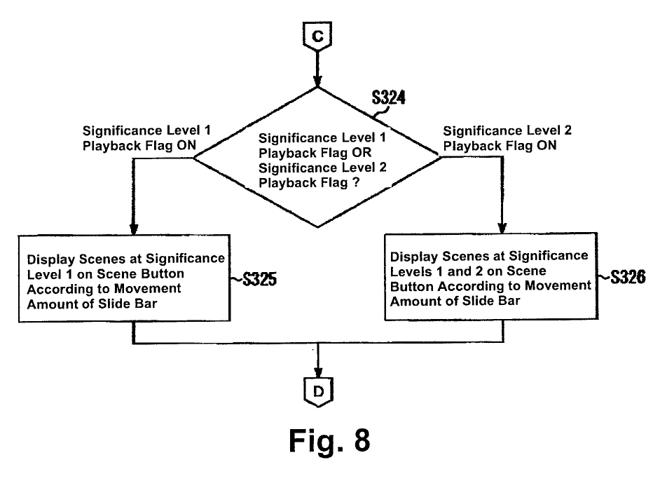

See FIG. 8. When the slide bar 509 is moved (step S323), the playback section 204 executes the processes for step S324 through step S326 shown in FIG. 8. In other words, the playback section 204 first checks which of the significance level 1 playback flag and the significance level 2 playback flag is “ON” (step S324).

When, as a result of this checking, the significance level 1 flag is found to be “ON,” the playback section 204 reads reduced images of the representative frames of the scenes at the significance level 1 from the scene information (see FIG. 3) in the scene information storage section 202, and displays the reduced images on the scene buttons 505 (X) according to the amount of movement of the slide bar (step S325).

On the other hand, if the significance level 2 flag is found to be “ON,” the playback section 204 reads reduced images of the representative frames of the scenes at the significance level 1 and the significance level 2 from the scene information (see FIG. 3) in the scene information storage section 202, and displays the reduced images on the scene buttons 505 (X) according to the amount of movement of the slide bar (step S326). The playback section 204 subsequently goes back to a standby mode to wait for an instruction from the user.

As described above, in accordance with the present embodiment, scene information including the length (scene interval), the significance level (the hierarchical level) and a reduced image of a representative frame of each of the scenes in a moving picture that is the subject of a playback is stored in the scene information storage section 202 (see FIG. 3). Reduced images of representative frames of scenes having significance levels equal to or higher than the significance level of the scene designated by the user through an operation of a button such as the significance level 1 button 507 or the significance level 2 button 508, are obtained from the scene information storage section 202 and displayed in chronological order in the scene button section 505, whereby the scene selected through the operation of the scene button 505 (X) in the scene button section 505 is played back.

As a result, if the moving picture that is played back is a video of a news program, for example, the user can initially play back only the scenes at the significance level 1 showing a news anchor by pressing the significance level 1 button 507. At this time, the scene button section 505 displays in chronological order the reduced images of representative frames of scenes with the news anchor, and then the user can play back a desired scene by pressing the scene button 505 (X) corresponding to the desired scene. As a result, the user can view the summary of each news item in the order he or she prefers.

Furthermore, by using frames with captions for each news item as the representative frames and by structuring to have those images displayed on the scene buttons 505 (X), the user can ascertain the summary of the news items merely through the images displayed on the scene buttons 505 (X) (the reduced images of the representative frames).

Also, when the user actually hears a summary as related by the news anchor through a scene playback and decides to view the details of the news item corresponding to the summary, the user can play back scenes designated significance level 2 by pressing the significance level 2 button. In other words, the user can also view the actual on-location scenes.

If, at this point, the user cannot decide whether to view all of the detail, for example, the user can determine if the content is of interest to him or her by looking at the reduced images of the representative frames from the on-location scenes (significance level 2 scenes) in chronological order in the scene button section 505. Moreover, the user can easily check scenes that cannot be displayed all at once in the scene button section 505 by operating the slide bar 509.

Through the operations described above, the user can view the desired scene and can continue viewing it if it is of interest to the user.

If, at this time, the content is not of interest to the user, the user can press the significance level 1 button 507. By doing this, images (reduced images of representative frames) of subsequent scenes at the significance level 1 (scenes with the news anchor) appear in the scene button section 505, and at the same time the playback of the next scene at the significance level 1 begins, so that the user can immediately view the summary of the next news item.

Consequently, according to the present embodiment, the user can easily determine whether to view the content in a greater detail by operating the scene button section 505 during the playback of a moving picture, such as instructing to display images of representative frames of long, more cohesive scenes or display images of representative frames of more detailed scenes. Additionally, due to the fact that the scene to be played back changes depending on the significance level of the scenes in the scene button section 505, the user can efficiently search for a scene of interest without interrupting his or her viewing.

Embodiments of the present invention can have any of the structures described in (1) through (7) below:

(1) In the embodiment described above, IDs are used to identify individual frames of the scenes in question, as indicated in FIG. 3. However, time codes, for example, can be used instead. Also, instead of using the number of frames to indicate the length of a scene, time, for example, can be used.

(2) In the embodiment described above, reduced images are stored in the scene information in FIG. 3 as images of representative frames of the scenes in question. However, IDs of the representative frames can be stored instead so that, when displaying an image, a representative frame indicated by a corresponding ID may be retrieved from the moving picture storage section 201, and a reduced image of the representative frame to be displayed may be created.

(3) In the embodiment described above, the significance level is in two levels for the sake of simplifying the description, but there can certainly be three or more levels. For example, if three significance levels are provided, a significance level 3 button may be provided in addition to the significance level 1 button 507 and the significance level 2 button 508 shown in FIG. 5. When the significance level 3 button is operated, scenes at the significance levels 1 through 3 are played back. At this time, the reduced images of frames from scenes having the significance level 1, the significance level 2 and the significance level 3 may be displayed with different frame shapes for the respective significance levels in the scene button section 505 in order to distinguish the significance levels from one another.

(4) In the embodiment described above, the image display on the scene button 505 (X) in the scene button section 505 is synchronous with the display on the playback window 501, but the image display on the scene button 505 (X) is not limited to this embodiment and can be asynchronous with the display on the playback window 501. Further, a button to alternately switch between synchronous and asynchronous display can be added.

(5) In the embodiment described above, the scene buttons 505 (X) in the scene button section 505 are horizontally arranged, but the scene buttons 505 (X) are not limited to this embodiment and can, for example, be vertically arranged.

(6) In the embodiment described above, buttons to designate the significance level (the significance level 1 button 507 and the significance level 2 button 508) may be formed from a radio button. However, they are not limited to a radio button and may be in any form as long as they are provided with similar functions.

(7) An object of the present invention can be achieved also by providing the system or the device with a storage medium that stores program codes for software that realizes the function of a host or a terminal of the present embodiment and by having the system or the device's computer (or CPU or MPU) read and execute the program codes stored in the storage medium.

The storage medium to supply the program codes can be a ROM, a floppy disk, a hard disk, an optical disk, a magnetic optical disk, a CD-ROM, a CD-R, a magnetic tape, a nonvolatile memory card or the like.

Further, by executing the program codes read by the computer, not only would the functions of the present embodiment be realized, but this would also encompass a situation in which the operating system running on the computer would perform a part or all of the actual processes based on the instructions in the program codes and the functions of the present embodiment would be realized through that process.

Moreover, once the program codes read from the storage medium are written in a buffer or a memory device of an expansion board that is inserted into the computer or of a functional expansion unit connected to the computer, this encompasses a situation in which a CPU or the like provided on the expansion board or the extension unit would perform a part or all of the actual processes based on the instructions in the program codes and the functions of the present embodiment would be realized through that process.

In other words, the foregoing description of embodiments has been given for illustrative purposes only and not to be construed as imposing any limitation.

The scope of the invention is, therefore, to be determined solely by the following claims and not limited by the text of the specification and alterations made within a scope equivalent to the scope of the claims fall within the true sprit and scope of the invention.

What is claimed is:

1. An image processing apparatus comprising:
a storage device that stores scene information including, at least, data for a representative frame of a scene, data for an interval of the scene and data for a hierarchical level of the scene of each of a plurality of scenes included in a moving picture that is subject to a playback;
a display device that reads images of the representative frames of the plurality of scenes from the storage device and chronologically displays the images based on an external designation of the hierarchical level; and
a playback device that plays back the scene corresponding to the images of the representative frames displayed by the display device based on an external playback instruction.

2. An image processing apparatus according to claim 1, wherein the display device chronologically displays a specified number of the images of the representative frames of the plurality of scenes concurrently.

3. An image processing apparatus according to claim 1, wherein the display device refers to the scene information in the storage device when a hierarchical level is externally designated, and chronologically displays images of the representative frames of the scenes having the hierarchical level designated and above.

4. An image processing apparatus according to claim 1, wherein the images of the representative frames included reduced images.

5. An image processing apparatus according to claim 1, wherein the display device displays the images of the representative frames with data indicative of the hierarchical level corresponding to the representative frames being added to the images of the representative frames.

6. An image processing apparatus according to claim 1, wherein the display device displays the scene played back by the playback device together with the images of the representative frames of the scenes, and displays data for discriminating representative frames corresponding to the scene being currently played back from the other representative frames.

7. An image processing apparatus according to claim 1, wherein the display device changes a display condition in the images of the representative frames of the scenes that are chronologically displayed based on an external instruction.

8. An image processing apparatus according to claim 6, wherein the display device changes a display condition in the images of the representative frames of the scenes that are chronologically displayed, synchronizing with the images being played back by the playback device.

9. An image processing apparatus according to claim 6, wherein the display device changes a display condition and selects whether change of the display condition is synchronized with the images being played back by the playback device, based on an external instruction.

10. An image processing apparatus according to claim 1, wherein the playback device plays back one of the scenes corresponding to one of the images of the representative frames of the scenes, which is externally designated among the images of the representative frames of the scenes displayed by the display device.

11. An image processing apparatus comprising:
a storage device that stores scene information including, at least, data for a representative frame of a scene and data for a hierarchical level of the scene of each of a plurality of scenes included in a moving picture that is subject to a playback; and
a display device that reads images of the representative frames of the plurality of scenes from the storage device and chronologically displays the images based on an external designation of the hierarchical level.

12. An image processing apparatus according to claim 11, wherein the display device refers to the scene information in the storage device when a hierarchical level is externally designated, and chronologically displays images of the representative frames of the scenes having the hierarchical level designated and above.

13. An image processing apparatus according to claim 11, wherein the images of the representative frames included reduced images.

14. An image processing apparatus according to claim 11, wherein the display device displays the images of the representative frames with data indicative of the hierarchical level corresponding to the representative frames being added to the images of the representative frames.

15. An image processing apparatus according to claim 11, wherein the display device changes a display condition in the images of the representative frames of the scenes that are chronologically displayed based on an external instruction.

16. An image processing method comprising:
storing scene information including, at least, data for representative frame of a scene, data for interval of the scene and data for a hierarchical level of the scene of each plurality of scenes included in a moving picture that is subject to a playback;
designating a hierarchical level;
chronologically displaying images of the representative frames of the scenes stored in the storing step, based on an external designation of the hierarchical level; and
playing back the scene corresponding to the images of the representative frames displayed by the display device based on an external playback instruction.

17. An image processing apparatus according to claim 16, wherein the display step chronologically displays a specified number of the images of the representative frames of the plurality of scenes concurrently.

18. An image processing method according to claim 16, wherein the images of the representative frames included reduced images.

19. An image processing method according to claim 16, wherein the display step displays the images of the representative frames with data indicative of the hierarchical level corresponding to the representative frames being added to the images of the representative frames.

20. An image processing method according to claim 16, wherein the display step displays the scene played back in the playback step together with the images of the representative frames of the scenes, and displays data for discriminating representative frames corresponding to the scene being currently played back from the other representative frames.

21. An image processing method according to claim 16, wherein the display step changes a display condition in the images of the representative frames of the scenes that are chronologically displayed based on an external instruction.

22. An image processing method according to claim 20, wherein the display step changes a display condition in the images of the representative frames of the scenes that are chronologically displayed, synchronizing with the images being played back in the playback step.

23. An image processing method according to claim 20, wherein the display step changes a display condition and selects whether changes of the display condition is synchronized with the images being played back in the playback step, based on an external instruction.

24. An image processing method according to claim 16, wherein the playback step plays back one of the scenes corresponding to one of the images of the representative frames of the scenes, which is externally designated among the images of the representative frames of the scenes displayed in the display step.

25. An image processing method comprising:
storing scene information including, at least, data for a representative frame of a scene and data for a hierarchical level of the scene of each of a plurality of scenes included in a moving picture that is subject to a playback; and
chronologically displaying images of the representative frames of the plurality of scenes stored in the storing step based on an external designation of the hierarchical level.

26. An image processing method according to claim 25, wherein the display step refers to the scene information in the storage device when a hierarchical level is externally designated, and chronologically displays images of the representative frames of the scenes having the hierarchical level designated and above.

27. An image processing method according to claim 25, wherein the images of the representative frames included reduced images.

28. An image processing method according to claim 25, wherein the display step displays the images of the representative frames with data indicative of the hierarchical level corresponding to the representative frames being added to the images of the representative frames.

29. An image processing method according to claim 25, wherein the display step changes a display condition in the images of the representative frames of the scenes that are chronologically displayed based on an external instruction.

30. A computer readable storage medium that stores image processing program codes for playing back a moving picture, the computer readable storage medium storing:
a code for storing scene information including, at least, data for a representative frame of a scene, data for an interval of the scene and data for a hierarchical level of the scene of each of a plurality of scenes included in a moving picture that is subject to a playback;
a code for chronologically displaying images of the representative frames of plurality of the scenes stored in the storing step based on an external designation of the hierarchical level; and
a code for playing back the scene corresponding to the images of the representative frames displayed in the display step based on an external playback instruction.

31. A computer readable storage medium that stores image processing program codes for playing back a moving picture, the computer readable storage medium storing:
a code for storing scene information including, at least, data for a representative frame of a scene and data for a hierarchical level of the scene of each of a plurality of scenes included in a moving picture that is subject to a playback;
a code for chronologically displaying images of the representative frames of the plurality of scenes stored in the storing step based on an external designation of the hierarchical level.
